(19) United States
(12) Patent Application Publication
(10) Pub. No.: US 2015/0149767 A1
(43) Pub. Date: May 28, 2015

(54) METHOD AND SYSTEM FOR AUTHENTICATING THE NODES OF A NETWORK

(71) Applicant: COMMISSARIAT A L'ENERGIE ATOMIQUE ET AUX ENERGIES ALTERNATIVES, Paris (FR)

(72) Inventors: Nouha Oualha, Les Ulis (FR); Alexis Olivereau, Orsay (FR); Christophe Janneteau, Chaudon (FR)

(73) Assignee: COMMISSARIAT A L'ENERGIE ATOMIQUE ET AUX ENERGIES ALTERNATIVES, Paris (FR)

(21) Appl. No.: 14/397,118

(22) PCT Filed: Apr. 15, 2013
(86) PCT No.: PCT/EP2013/057835

§ 371 Date: Oct. 24, 2014

(30) Foreign Application Priority Data
Apr. 26, 2012 (FR) 1253828

(51) Int. Cl. H04L 29/06; H04L 9/32

(52) U.S. Cl. CPC H04L 63/0884; H04L 9/3271
USPC 713/155; 726/3

(57) ABSTRACT

A system and a method are provided for authenticating the nodes of a communication network in order to access the services of a service provider, and includes a collective authentication of the nodes, performed in a single exchange between the nodes of the network declared in a group and an authentication server. Depending on the result of the authentication, the service provider is provided with cryptographic material in order to implement individualized controlled access to the resources or to the services offered for each node.

### FIELD OF THE INVENTION

The invention relates to the field of security in communication networks and in particular the authentication of nodes in low-resource networks.

### State of the Art

Currently, the authentication of the nodes in a low-resource network is done individually. Either each node is authenticated with its real or vertical identity, or it is authenticated by being identified as a member of a group of nodes.

A well-known situation for authenticating a plurality of nodes consists in conducting, in succession or in parallel, several individual authentications. The technology that is most widely used is the “extensible authentication protocol” (or EAP) described in the document “extensible authentication protocol (EAP)”, IETF RFC 3748, June 2004 by B. Aboba et al., which defines how a client is authenticated to a server.

By serializing the independent individual authentications, the server considers each authentication procedure as strictly independent, which leads to a significant consumption of resources such as communication energy costs or reduced bandwidth. Another limitation is that it is impossible for the server to use the EAP protocol to send security parameters to the service provider.

In order to limit the overload on an authentication server, systems have been proposed which make it possible to delegate the authentication functionality of the server to other nodes of the network. Thus, in the third generation cellular networks, the “authentication and key agreement” protocol by B. Aboba et al. or (AKA) implemented for authentication and bootStrapping provides in particular for delegating the capacity to authenticate the mobile station and to be authenticated by it from a “home subscriber server” (or HSS) to a “bootStrapping function” (or BSF) of the service provider. To this end, authentication vectors are handed over from the HSS to the BSF which are then used in the context of a local authentication between the BSF and the user equipment (or UE). However, the handover of these parameters is not aggregated when a number of distinct users want to be authenticated with the same BSF. Furthermore, the authentication vectors are strictly relative to a single user and must be generated for each client by the HSS.

An authentication method for machine-to-machine communications is proposed in the document [CN102088668, “Group-based authentication method of machine type communication (MTC) devices”, Xidian University, 2011]. This method makes it possible to authenticate a group of nodes as a single unit. The nodes are registered in a group by a “machine-type communication” (or MTC) server. By being based on a group authentication vector, the nodes are authenticated to the authentication center (AUC) as being members of this group.

Similarly, the method described in the patent application WO2011131052 by Tian Tian et al. entitled “Procédé et Système d'Authentification par Groupes dans les Systèmes de Communication de Machine-à-Machine”, makes it possible to authenticate a group of nodes in an MTC network by being based on group cryptographic material generated by an authorization center and sent to an “access security management equipment” (ASME).

These two methods of group authentication make it possible to reduce the traffic at the infrastructure level, either between the MTC server and the AUC for the first method, or between the authorization server and the ASME for the second method. However, they do not make it possible to reduce the number of messages exchanged in the MTC network which is generally a low-resource network.

There is then the need for a solution which allows for a collective authentication of the nodes of a group in which all the members of the group are authenticated in a single exchange.

The present invention addresses this need.

### SUMMARY OF THE INVENTION

One aim of the present invention is to provide a method for collective authentication, in a single exchange, of a group of nodes in a communication network.

Another aim of the invention is to allow nodes of a network to be authenticated with a service provider by using an authentication server and, depending on the result of the authentication, to supply the service provider with cryptographic material in order to implement individualized controlled access to the resources or to the services offered.

Advantageously, the present invention applies when the members of a group want to simultaneously access resources or services administered by a remote infrastructure.

Another advantage of the present invention is a lesser consumption of resources in terms of bandwidth in the network and a lesser consumption of energy at the nodes than in the individual node authentication methods.

Another advantage is that the controlled access to the resources and services remains individualized for each of the members of the group.

Advantageously, the invention allows the messages from an authentication server to be broadcast to the group in a multicast routing tree and the authentication messages from the nodes to be referred to the server by a reverse multicast method, by aggregating the content of the messages.

Another aim of the present invention is to be able to manage situations in which certain members of a group are failing or disconnected or else when a limited number of nodes of a group fail in the aggregate authentication.

Advantageously, the invention allows an authentication server to authenticate and export, for each of the nodes of a group, security parameters such as keys, access rights, to the service provider.

Advantageously, the present invention is implemented in the context of security services such as “bootStrapping” initial authentication, re-authentication and authorization.

Still advantageously, but in a nonlimiting manner, the invention will be applicable in the industrial fields of machine-to-machine communication security.

To obtain the results sought, a method as described in independent claim 1, a system as described in independent claim 10 and a computer program product as described in claim 12 are proposed.

In particular, a method for authenticating a group of nodes from a plurality of nodes of a communication network, the method comprising the steps of:
identifying, out of the plurality of the nodes, a group of nodes to be authenticated;
generating a challenge for the group of nodes;
sending the challenge from an authentication server to a first node of the plurality of nodes;
broadcasting the challenge from the first node to all of the nodes of the group of nodes according to a multicast routing tree;
aggregating, at the first node according to a multicast routing tree that is the reverse of the multicast routing tree, the responses to the challenge from the nodes of the group;
sending the aggregate of the responses to the authentication server;
checking the aggregate of the responses; and
generating a success message for the group of nodes if the collective check is successful.

Different variant implementations are described in the dependent claims.

### DESCRIPTION OF THE FIGURES

Different aspects and advantages of the invention will become apparent based on the description of a preferred, but nonlimiting, implementation of the invention, with reference to the figures below:

FIG. 1 is a topological representation of a network infrastructure in which to advantageously implement the invention;

FIG. 2 shows the steps carried out for the method of the present invention to authenticate the nodes of a group;

FIG. 3 shows the exchanges carried out between the nodes of a group and the authentication server in a preferential implementation of the invention;

FIG. 4 illustrates a variant implementation of the exchanges of FIG. 3.

### DETAILED DESCRIPTION OF THE INVENTION

The invention applies advantageously to a network formed from nodes having low resources, and in which certain nodes have to access a resource or a service associated with a remote infrastructure. Examples of low-resource networks are the networks of sensors which are increasingly deployed in the industrial field and vehicle networks.

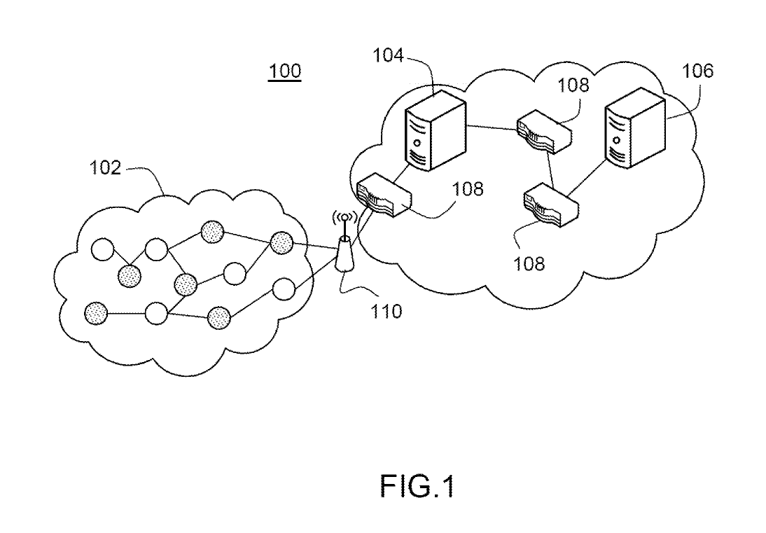

FIG. 1 shows an example of a general context 100 in which to advantageously implement the invention. A group of nodes (102) made of equipment with low resources has to access services or resources associated with a service provider (104) of a remote infrastructure. The services or the resources required can be connectivity or data requirements. The nodes can be mobile or static and are connected to the remote network through a gateway (110). The service-providing server can, in a variant implementation, be co-located on the gateway, as for example in the case of a network access.

In order to have access to these services or resources, the nodes must be authenticated with an authentication server (106).

The remote infrastructure can contain intermediate entities such as routers (108).

In order to keep the description simple and avoid imposing limitation on the invention, the example of FIG. 1 shows only a finite number of entities and of connections, but a person skilled in the art will extend the principles described for the present invention to a plurality and a variety of nodes of a group and of server, gateway or connection type (wireless, mobile, very high bit rate).

The network of nodes (102) can be based on level 2 communications (for example, 802.15.4 or 802.11) or level 3 communications (for example, IP). According to the protocols on which it relies, multicast or broadcast communication schemes can be employed therein.

Such a global network forms what is referred to as a web of things (WoT). It covers two types of communication:
from object to person;
from object to object, or machine to machine (M2M).

These communications can be set up in a limited context (a single protocol employed, for example ZigBee and/or a single target scenario, for example the Smart Grid) in which case the term “intranet of things” applies, or their function can be to allow for a large number of distinct services, while relying on numerous communication protocols, in which case the term “Internet of things” applies. Generally, an Internet of things should be understood to mean an architecture which allows for the interconnection of the conventional Internet with communicating or perceived objects, and which relies on decentralized communication schemes, while implementing autonomous mechanisms.

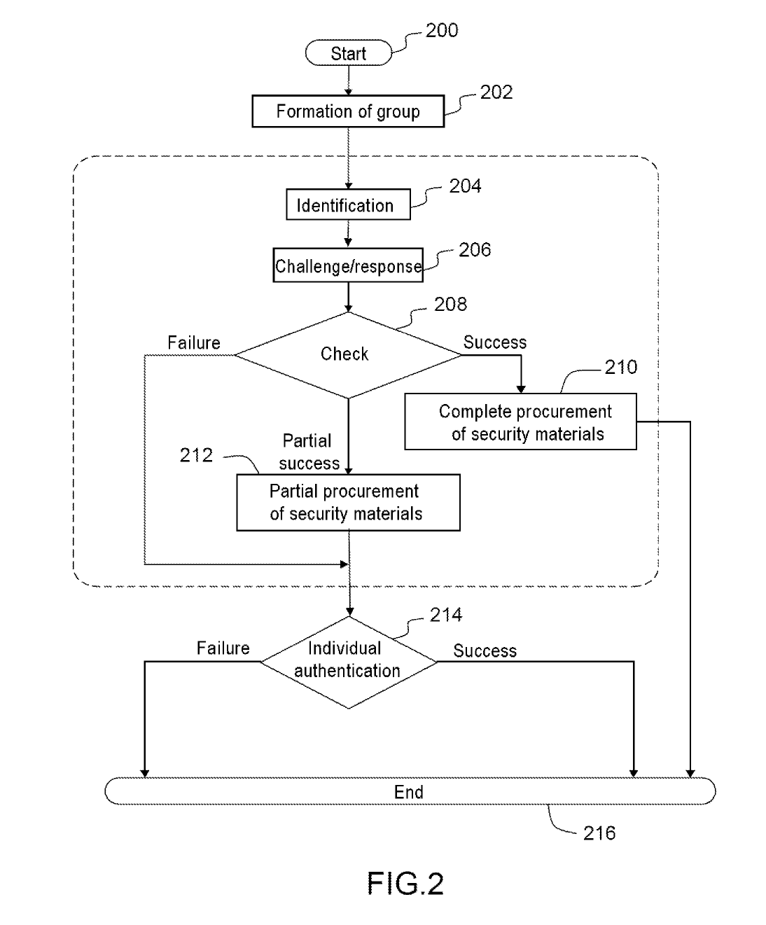

The authentication server (106), responsible for the authentication of the nodes, stores the cryptographic data necessary for the authentication of each of the nodes of the group (102). If the collective authentication, as described later with reference to FIG. 2, is validated, the authentication server derives and sends the security parameters (the session keys, the access rights) of each of the nodes of the group to the service provider (104). The service provider then establishes a security association with each of the nodes.

The service provider (104) can, in a first variant implementation, not be involved in the exchanges for the authentication of the nodes of the group (102). In this case, the authentication server (106) exports the associated security parameters to the nodes, after a successful authentication, in a separate message from a successful authentication message intended for the group of the nodes.

Alternatively, in another implementation, the authentication exchanges are relayed by the service provider (104). Such a situation can occur when the service provider provides access to the network. In this case, after a successful authentication, the security parameters are transferred to the service provider (104), according to two variants:
in a first variant, the security parameters are transferred in a separate message from the successful authentication message intended for the group of the nodes;
in a second variant, the security parameters are transferred with the successful authentication message intended for the group of the nodes. This variant implementation is the one retained hereinbelow in the description.

FIG. 2 shows the method (200) applied by the method of the present invention for authenticating the nodes of a group.

The step (202) consists in forming a group of nodes. The formation of the group of the nodes can be done spontaneously or prior to the authentication.

For a spontaneous group formation, the nodes can be grouped on the basis of criteria of temporal and geographic proximity or of common interest in the services offered by the service provider. The identities of the nodes are sent for authentication to the authentication server which will construct a group model by combining all the received node identities in a single set.

Alternatively, in the case of a prior formation, the group of the nodes is formed by using a multicast group address.

Advantageously, in a variant implementation, once the group is formed and designated, a multicast routing tree is constructed to allow for the broadcasting of messages from the authentication server within the group.

Simultaneously, another, reverse multicast routing tree is constructed. The reverse routing tree considers the members of the group as sources/senders of broadcast messages and the authentication server as target/receiver of these messages.

A person skilled in the art will be able to refer to the known multicast routing tree construction techniques, like the “RPL” protocol described by T. Winter et al., in “RPL: IPv6 Routing Protocol for Low power and Lossy Networks”, IETF Internet Draft in progress, draft-ietf-roll-rpl-19, Mar. 13, 2011. This protocol, which is dedicated to low-resource networks, can advantageously be used in the context of the invention. However, any routing protocol supporting means for broadcasting from a single point to multiple points for the construction of the first multicast routing tree and from multiple points to a single point for the construction of the reverse multicast routing tree can be used. One variant for constructing the reverse multicast routing tree is based on the first multicast routing tree, by having each child node in the tree send the message to its parent node as identified by the multicast routing tree.

Intermediate entities, such as, for example, the gateway (110), clusterheads or intermediate nodes of the network, belonging or not belonging to the group of nodes, are responsible for broadcasting the messages from the authentication server to these nodes and for the aggregation of the messages from the nodes intended for the server in return.

In the step (204), the collective authentication process is initiated, and an identification request is sent. The request is sent from the authentication server to the nodes.

If the group of nodes was formed spontaneously according to determined grouping criteria, each node responds to the reception of the request with its identity. The identity of each node can take the form, for example, of a “network access identifier” (or NAI) as described in the document “The Network Access Identifier”, IETF RFC 4282 by B. Aboba et al., December 2005.

The authentication server receives the identities of the nodes either in separate messages or concatenated in a single message.

If the group of nodes was formed previously, each node responds upon the reception of the identification request with the identity of the group (multicast address). The message containing the identity of the group is aggregated all along the “reverse multicast” routing tree.

Alternatively, the identification request may not be broadcast within the group of nodes but only sent to an intermediate entity in the network, such as, for example, the gateway, a router or a “cluster-head”. The intermediate entity is responsible for responding to the identification request with the identity of the group.

In a variant implementation in which the authentication server knows the identity of the nodes implicitly from the message received as response to its authentication challenge, the identification step can then be omitted.

In the step (206), an exchange of “challenge-response” messages takes place between the nodes of the group and the authentication server. Advantageously, the invention makes it possible to authenticate a group of nodes in a single exchange. The authentication server sends a request to the nodes. The origin of the request is authenticated by the nodes by means of a known authentication method. The authentication of the server can be done by an MAC signature with a key generated according, for example, to the “TESLA” protocol described by A. Perrig et al., in “The TESLA Broadcast Authentication Protocol”, UC Berkeley and IBM Research, 5(2), 2002.

In the group of nodes, the responses from the nodes are aggregated by using authentication message aggregation functions which make it possible to guarantee, on the one hand, the integrity of the aggregate of the responses and, on the other hand, the verification of the identities of the senders. A person skilled in the art will be led to apply known commutative aggregation functions, such as, for example, the MAC aggregation schemes described by J. Katz et al., in “Aggregate message authentication codes”, in Proceedings of the 2008 The Cryptopgraphers' Track at the RSA conference on Topics in cryptology, Tal Malkin (ed.). Springer-Verlag, Berlin, Heidelberg, 155-169. Alternatively, quasi-commutative functions can be applied, such as, for example, the one-way accumulative functions described by J. Benaloh et al., in “One-way accumulators: a decentralized alternative to digital signatures”, Advances in Cryptology-Eurocrypt' 93, LNCS, vol. 765, Springer-Verlag, 1993, pp. 274-285.

Advantageously, schemes based on encryption algorithms or homomorphic signatures, like that described by C. Castellucia et al., in “Efficient aggregation of encrypted data in wireless sensor networks”, in Mobile and Ubiquitous Systems: Networking and Services, 2005, may also be envisaged.

In a variant implementation, if a mutual authentication is not required, the authentication of the authentication server by the nodes may be omitted.

In a preferential implementation in which the group of nodes is identified by a multicast address, the challenge sent by the authentication server is broadcast to all the nodes of the group according to the previously constructed multicast routing tree. The responses from the nodes are aggregated by a parent node as they are transported over the “reverse multicast” routing tree.

When the responses are received, the aggregating node aggregates them and the aggregate of the responses is transmitted in “reverse multicast” mode.

As will be detailed later, if nodes have not responded to the challenge after a predefined waiting time, the router adds to the aggregates of the responses the identity of the defaulting nodes in an “NACK” message. The authentication server can identify each defaulting or disconnected node in the tree structure of the multicast routing tree and authenticate them directly by means of an individual authentication protocol.

Advantageously, if a router belongs to the declared group of nodes, it computes its own response to the challenge and collects the responses of the responding nodes in its subtree. The router adds its response to the responses received and aggregates them all.

In a variant implementation in which a router does not have any aggregation function, the received responses are transmitted directly to another router, placed higher up in the reverse routing tree, which can be responsible for aggregating them.

The aggregate of the responses is transmitted to the authentication server, and can be relayed by the service provider in a variant implementation.

The next step (208) of the method consists, for the authentication server, in checking the integrity of the aggregate of the responses received and the identities of its senders. The server uses cryptographic material specific to each member of the group, such as, for example, keys shared with each of the members of the group or public keys associated with the private keys of each of the members of the group, to carry out the check.

If the check fails, the authentication server sends a failure message to the nodes. The method continues with an individual authentication (214).

If the check is entirely correct, the authentication server sends a success message to the nodes of the group and the method continues with the step (210).

If the check is only partially successful, the authentication server sends an individual success or failure message respectively to each node depending on the result of the check. Then, the method continues with the step (212).

The subsequent steps (210 and 212) consist in providing the service provider with security material either completely (210) or partially (212). The authentication success or failure message sent by the authentication server to the nodes is also sent to the service provider. Alternatively, the service provider can also be the relay of the success or failure message to the nodes.

If the checking step (208) is successful, the authentication server attaches to the success message cryptographic material intended for the service provider. The term “cryptographic material” should be understood in this description to mean any information, data, that can be used to establish an authentication, such as keys, access rights, identities or certificates for example. The cryptographic material enables the service provider to establish a security association with each node that has been verified. The cryptographic material is derived from material that the authentication server established individually with each node.

Advantageously, the authentication server can attach to the success message a group key associated with the group of the nodes and intended for the service provider, in the case where all the nodes of the group are authenticated.

After the step (210) of complete provision of security material the collective authentication method is terminated (216).

After the checking step (208) having led to a failure or to a partial provision of security material (212), the method continues with an individual authentication step (214).

If the verification is partial, the authentication server applies an individual authentication protocol to individually check the nodes that are not authenticated on completion of the collective authentication.

Then, the authentication method is terminated (216).

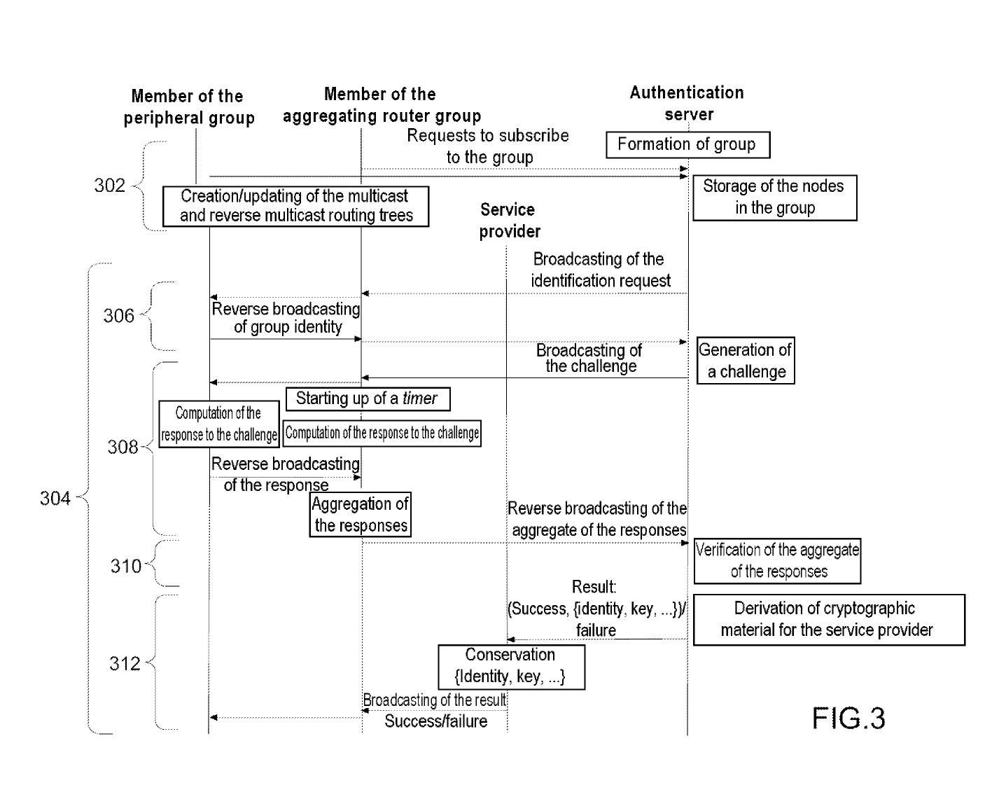

FIG. 3 shows the exchanges carried out between the nodes of a group and the authentication server in a preferential implementation of the invention.

In an initial phase (302), the group of nodes is formed and the routing trees are defined.

The authentication server learns about the group, for example from a group management center. Alternatively, the server itself manages the group (the group management center is co-located with the authentication server) and manages requests applying for registration of the nodes to this group.

The group forming phase is thus performed once for a group, and is then adapted in line with the dynamics of the group, for example by registration of new members or unsubscription of members. This phase remains independent of the choice of the service provider.

The “multicast” and “reverse multicast” routing trees are created with the members of the group, in which certain nodes are defined as aggregating router for aggregating responses from the peripheral nodes and broadcasting an aggregated response to the authentication server.

The next phase (304) consists in the collective authentication of the nodes of the group, and combines the intermediate phases 306 to 312.

In the phase (306), an identification request is broadcast in the multicast routing tree to the nodes of the group. The nodes respond and a message containing the identity of the group is broadcast in the reverse multicast routing tree to the authentication server.

In the next phase (308) the authentication server generates a challenge which is common to all the nodes of the group. The challenge is broadcast in the multicast routing tree to all the nodes. Each node which operates as aggregator initiates a counter which will measure the response time of the peripheral nodes that are attached to it in the reverse multicast routing tree. This time is known as the “roundtrip time” (or RTT).

In a preferential implementation, in the absence of a response from a node of the group to the identification request after a limited time has elapsed, computed on the basis of the RTT in its multicast sub-tree, a negative acknowledgement (or NACK) is sent. The absence of a response may be due to a standby state of the node or to an inaccessibility or failure. The negative acknowledgement (NACK) is attached by the router node to the response in the reverse routing tree.

Advantageously, the router checks that the total number of the “NACKs” does not exceed a threshold number to avoid considerably extending the length of the message returned in reverse multicast mode, otherwise, the router does not respond to the request.

The responses from the nodes to the challenge are returned to a router node. The parent router node in the reverse multicast routing tree aggregates the received responses and returns the aggregate of the responses to the authentication server.

For the aggregation of the responses, the role of a node changes according to its place in the “reverse multicast” routing tree. If a node occupies a peripheral place, then it computes its response and sends it directly, as soon as it receives the challenge. If a node acts as router in the “reverse multicast” routing tree, it aggregates the received responses.

A person skilled in the art will understand that the root of the multicast tree, for example the authentication server or the gateway, may be aware of the tree structure of the “reverse multicast” routing tree to be able to determine the members of the group which will not participate in the collective authentication of the group.

In a phase (310), the authentication server checks the aggregate message received. Preferentially, the authentication server comprises authentication message aggregation functions, and can thus authenticate the members of the group.

After a successful authentication of all the members of the group, the server sends to the service provider, in a subsequent phase (312), the cryptographic security material (for example cryptographic keys), as well as other parameters (for example access rights, security contexts). Such security information which is specific to each of the members of the group makes it possible to create security associations between the service provider and each of the members of the group.

In a variant implementation in which the service provider is not involved in the authentication exchanges, the authentication server exports the security parameters associated with the nodes, after a successful authentication, in a message that is separate from the successful authentication message intended for the group of the nodes.

In another variant implementation, the authentication exchanges are relayed by the service provider. In this case, the security parameters can be transferred to the service provider, after a successful authentication, either in a message that is separate from the successful authentication message intended for the group of the nodes, or jointly with the successful authentication message intended for the group of the nodes.

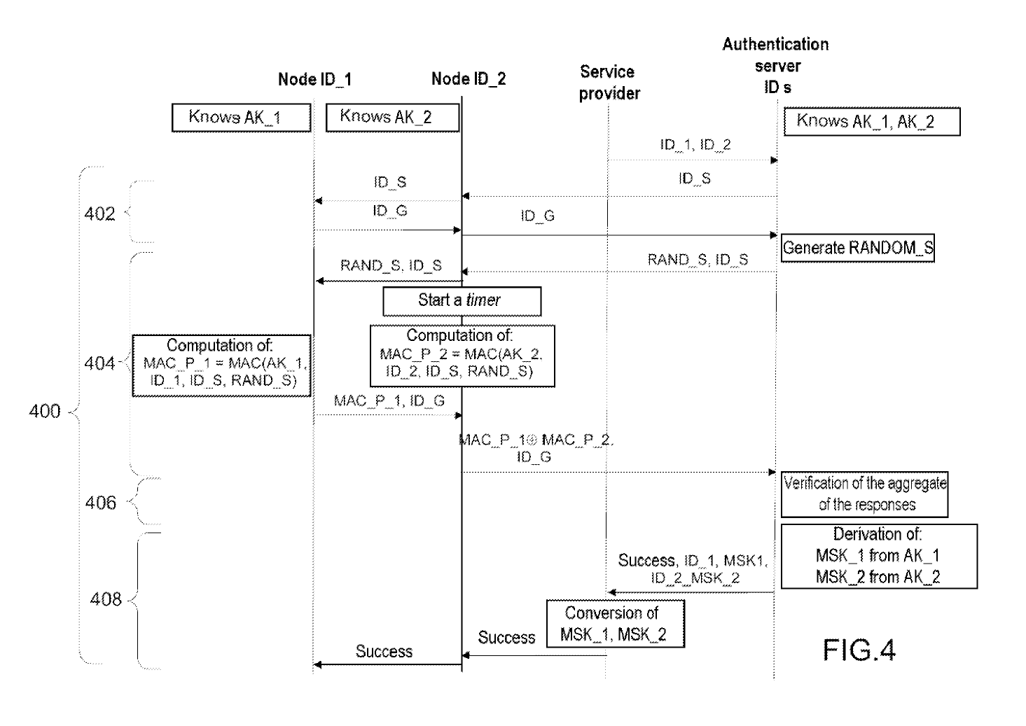

FIG. 4 illustrates the exchanges that occur in an implementation of the authentication method of the present invention based on the EAP-PSK protocol. The EAP-PSK protocol is described by F. Bersani et al. in “The EAP-PSK Protocol: A Pre-Shared Key Extensible Authentication Protocol (EAP) Method”, IETF RFC 4764, 2007.

Only the elements specific to the present invention are described, and a person skilled in the art will refer to the available literature for the general principles linked to the “EAP-PSK” protocol. FIG. 4 is based on the example of two nodes to simplify the description, but is in no way limiting. The implementation described (400) allows for the authentication of the nodes of one and the same group in a single exchange between the authentication server and the group of nodes, the exchange being represented by a challenge {RAND_S, ID_S} broadcast from the server to the group of nodes, and a response {MAC_P, ID_G} from the group of nodes received by the server.

After a phase (not shown) of formation of the group of nodes, an identification phase (402) comprising the identities (ID_1, ID_2) of the nodes of the group (ID_G) is initiated.

After the identification phase, a challenge generation and response aggregation phase (404) is applied.

The server (ID_S) generates a first message (RAND_S, ID_S) sent to the group of nodes and broadcast within the group according to the defined multicast routing tree. The message contains a random challenge (RAND_S) to which each node will respond.

Each node computes its response to the challenge. As illustrated, the peripheral node (ID_1) computes:
MAC_P_1 =MAC(AK_1, ID_1, ID_S, RANS_S), and the aggregator node ID_2 computes its response:
MAC_P_2 =MAC(AK_2, ID_2, ID_S, RANS_S),
   in which AK_1 is the key shared between the node ID_1 and the authentication server and
   AK_2 is the key shared between the node ID_2 and the authentication server.

The peripheral node (ID_1) sends its response to the aggregator node according to the reverse routing tree in a message (MAC_P_1, ID-G).

The aggregator node (ID_2) aggregates the received responses, and an aggregate of the responses is generated:
MAC_P=\textcircled{+}{MAC(AK_i, ID_P_i, ID_S, RANDS)}
   in which “MAC_P” designates the XOR sum of the MACs computed by each node of the group identified by ID_P_i, and in which:
AK_i designates the key shared between the node ID_P_i and the server ID_S; and
ID_G designates the identity of the group of nodes.

A second message is generated from the responses of the nodes aggregated progressively throughout the “reverse multicast” tree. The aggregate of the responses is returned to the authentication server.

The nodes are authenticated with the authentication server by demonstrating that they are capable of computing MAC values from their keys shared with the server.

On receiving the second message, the authentication server checks the aggregate of the responses (406). It computes the XOR sum of the MACs by using the keys shared with the nodes, and compares the result with the received response.

If the comparison matches, the authentication server derives (408) the cryptographic material for the service provider and generates (MSK_1) from (AK_1) and (MSK_2) from (AK_2). “MSK” designates the “Master Session Key”, according to the terminology of the protocol (EAP), and corresponds to the key generated by the server and the node on completion of a successful authentication. The MSK is transported from the authentication server to the service provider.

The authentication server sends the service provider a validation message (success, ID_1, MSK_1, ID_2, MSK_2) and the cryptographic elements generated.

The service provider retains the keys (MSK_1, MSK_2) of the nodes and returns a validation message to the group of nodes.

A person skilled in the art will appreciate that variations can be made to the method as described preferentially, while maintaining the principles of the invention. Thus, it is possible for the authentication to be done through an entity belonging to the domain of the service provider or other entities of the infrastructure, such as, for example, the gateway 110. The authentication server then delegates the authentication to this entity by providing it with the material necessary for the authentication as well as parameters concerning each user. The material for the authentication can, for example, be authentication vectors like those described in [3GPP TS 33.220, “Generic Authentication Architecture (GAA); Generic Bootstrapping Architecture (GBA)”, Release 11 v11.1.0, December 2011].

In an advantageous variant, a number of groups can be authenticated in a single exchange. The identities of the groups and the aggregated responses associated with a common challenge can be concatenated before being transmitted to the authentication server for verification.

In a novel variant, the aggregation can be done on parts of the multicast routing tree. For each sub-tree, a multicast group is dynamically created and processed according to the principles of the method of the present invention. The aggregates of the responses on each of the parts of the tree are concatenated and transmitted to the authentication server. The authentication fails only on the parts effected by a virile attack or other types of attacks, the nodes on the other parts of the tree are, by contrast, correctly authenticated.

Advantageously, specific routers in the multicast routing tree can be defined to check the aggregates of the responses received before transmitting them to other routers, in order to limit the virile attacks by malicious routers.

In an advantageous variant, the multicast routing tree can consist of a secured “overlay” logical network consisting solely of the members of the group with security associations established between them.

The present invention can be implemented on the basis of hardware and/or software elements. It can be available as computer program product on a computer-readable medium. The medium can be electronic, magnetic, optical, electromagnetic or be a broadcast medium of infrared type. Such media are, for example, semiconductor memories (Random Access Memory RAM, Read-Only Memory ROM), tapes, diskettes or magnetic or optical disks (Compact Disk—Read Only Memory (CD-ROM), Compact Disk—Read/Write (CD-R/W) and DVD).

Thus, the present description illustrates a preferential implementation of the invention, that is not limiting. An example has been chosen to allow for a good understanding of the principles of the invention, and a concrete application, but it is in no way exhaustive and should allow a person skilled in the art to add modifications and variant implementations while retaining the same principles.

1. A method for authenticating a group of nodes from a plurality of nodes of a communication network, the method comprising the steps of:
identifying, out of the plurality of the nodes, a group of nodes to be authenticated;
generating a challenge for the group of nodes;
sending the challenge from an authentication server to a first node of the plurality of nodes;
broadcasting the challenge from the first node to all of the nodes of the group of nodes according to a multicast routing tree;
aggregating, at the first node according to a multicast routing tree that is the reverse of the multicast routing tree, the responses to the challenge from the nodes of the group;
sending the aggregate of the responses to the authentication server;
checking the aggregate of the responses; and
generating a success message for the group of nodes if the collective check is successful.

2. The method as claimed in claim 1, in which the step of identifying a group of nodes to be authenticated further comprises a step of storing the identities of the nodes of the group of nodes to be authenticated.

3. The method as claimed in claim 1, comprising, after the step of identification of the group of nodes, a step of constructing a multicast routing tree for broadcasting messages to the nodes of the group.

4. The method as claimed in claim 1, comprising, after the step of identification of the group of nodes, a step of constructing a reverse multicast routing tree for broadcasting messages from the nodes of the group.

5. The method as claimed in claim 1, comprising, before the step of generation of a challenge, a step of emitting a request for identification of the nodes of the group of nodes to be authenticated.

6. The method as claimed in claim 1, further comprising a step of initiating a counter to measure the response times of the nodes to the challenge.

7. The method as claimed in claim 5, in which the step of broadcasting of the identification request and/or broadcasting of the challenge to the nodes of the group is formed according to the multicast routing tree.

8. The method as claimed in claim 1, further comprising a step of generating an authentication success message for each authenticated node or a failure message for each non-authenticated node.

9. The method as claimed in claim 8, in which the success message further comprises cryptographic material having keys, access rights or certificates.

10. A system for authenticating a plurality of nodes in a communication network comprising means for implementing the steps of the method as claimed in claim 1.

11. The system as claimed in claim 10, comprising an authentication server remote from the group of nodes, the server being in communication with a service provider capable of receiving the cryptographic material after a successful collective authentication of the group of nodes.

12. A computer program product, said computer program comprising code instructions making it possible to perform the steps of the method as claimed in claim 1, when said program is run on a computer.
